(19) United States
(12) Patent Application Publication
(10) Pub. No.: US 2014/0357438 A1
(43) Pub. Date: Dec. 4, 2014

(54) Image Forming Apparatus

(71) Applicant: BROTHER KOGYO KABUSHIKI KAISHA, Nagoya-shi (JP)

(72) Inventor: Tomoya Yamamoto, Nagoya-shi (JP)

(73) Assignee: BROTHER KOGYO KABUSHIKI KAISHA, Nagoya-shi (JP)

(21) Appl. No.: 14/230,220

(22) Filed: Mar. 31, 2014

(30) Foreign Application Priority Data
May 30, 2013 (JP) 2013-114265

(51) Int. Cl. F16H 7/12

(52) U.S. Cl. CPC F16H 7/12
USPC 474/118

(57) ABSTRACT

An image forming apparatus including a pressing mechanism that applies a tension to a belt that is wound around a drive section and an input section and configured to transmit a driving force from the drive section to the input section, the belt including an urging member, and a swing member that swings to press the belt when urged by the urging member, the swing member including a pivot portion that serves as a pivot point around which the swing member swings, a first end portion that is spaced apart in a first direction from the pivot portion and configured to contact the belt, and a second end portion that is spaced apart, in a second direction different from the first direction, from the pivot portion and configured to be urged by the urging member.

### CROSS-REFERENCE TO RELATED APPLICATION

This application claims priority under 35 U.S.C. §119 from Japanese Patent Application No. 2013-114265 filed on May 30, 2013. The entire subject matter of the application is incorporated herein by reference.

### BACKGROUND

1. Technical Field

The following description relates to one or more techniques for an image forming apparatus configured to form an image on a sheet in an electrophotographic method.

2. Related Art

As an image forming apparatus, a printer has been known that includes a driving source configured to generate a driving force, and a gear spaced apart from the driving source and configured to transmit the driving force from the driving source to a rotational body such as a development roller.

As an example of the known printer, a printer has been proposed that includes a belt wound around the driving source and the gear, so as to transmit the driving force generated by the driving source to the gear.

Specifically, the proposed printer further includes a tensioner, which includes a roller configured to contact the belt, and a compressive spring configured to urge the roller toward the belt, so as to externally urge the belt and apply an appropriate tension to the belt.

### SUMMARY

In the proposed printer, it is required to urge the belt in a direction substantially perpendicular to a traveling direction of the belt in order to apply the appropriate tension to the belt. Therefore, there is a problem that the tensioner, which includes the roller and the compressive spring, has to be disposed in restricted locations.

Aspects of the present invention are advantageous to provide one or more improved techniques, for an image forming apparatus, which make it possible to certainly apply a tension to a belt with a simple configuration.

According to aspects of the present invention, an image forming apparatus is provided that includes a driving source configured to generate a driving force, a drive section configured to receive the driving force from the driving source, an input section spaced apart from the drive section, the input section configured to input, to an image forming unit, the driving force transmitted from the driving source via the drive section, a belt wound around the drive section and the input section, the belt configured to transmit the driving force from the drive section to the input section, and a pressing mechanism configured to apply a tension to the belt, the pressing mechanism including an urging member, and a swing member configured to swing to press the belt when urged by the urging member, the swing member including a pivot portion configured to serve as a pivot point around which the swing member swings, a first end portion spaced apart in a first direction from the pivot portion, the first end portion configured to contact the belt, and a second end portion spaced apart, in a second direction different from the first direction, from the pivot portion, the second end portion configured to be urged by the urging member.

### BRIEF DESCRIPTION OF THE ACCOMPANYING DRAWINGS

FIG. 1 is a cross-sectional side view showing a printer in an embodiment according to one or more aspects of the present invention.

FIG. 2 is a perspective view showing an internal configuration of a left wall of a main body casing of the printer when viewed from a left front side in the embodiment according to one or more aspects of the present invention.

FIG. 3 is a cross-sectional side view showing a mechanism for transmitting a driving force in the printer in the embodiment according to one or more aspects of the present invention.

FIG. 4A is an enlarged view of a particular part showing the mechanism for transmitting the driving force in the printer shown in FIG. 2 in the embodiment according to one or more aspects of the present invention.

FIG. 4B is a cross-sectional view taken along an A-A plane shown in FIG. 3 in the embodiment according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

Hereinafter, an embodiment according to aspects of the present invention will be described with reference to the accompanying drawings.

1. Overall Configuration of Printer

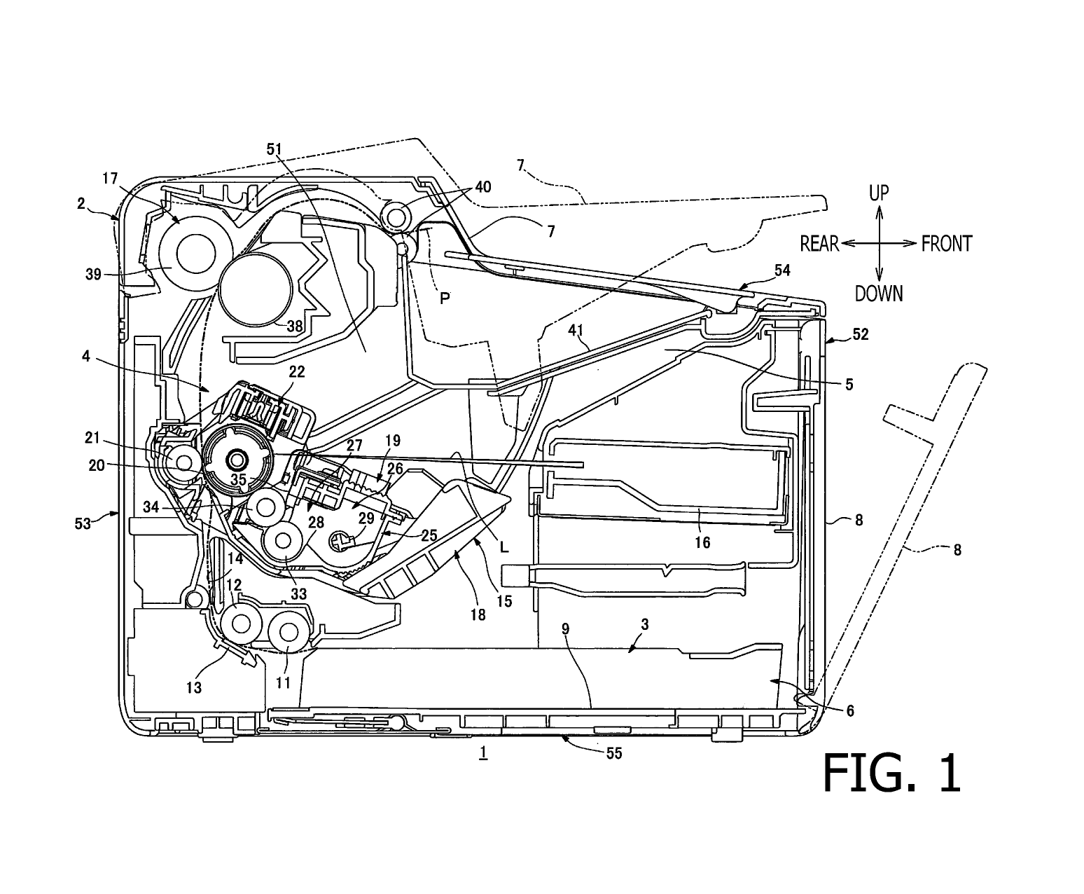

As shown in FIG. 1, a printer 1 of the embodiment includes a main body casing 2.

The main body casing 2 is formed substantially in a box shape. The main body casing 2 includes, in an internal space thereof, a sheet feeder 3 configured to feed a sheet P, and an image forming unit 4 configured to form an image on the sheet P fed from the sheet feeder 3.

In the following descriptions, upside and downside of the printer 1 will be defined with a vertical direction as a vertically-extending direction in a situation where the printer 1 is horizontally installed. Namely, the upper side of FIG. 1 will be defined as an upside of the printer 1. The lower side of FIG. 1 will be defined as a downside of the printer 1. Further, the right side of FIG. 1 will be defined as a front side of the printer 1. The left side of FIG. 1 will be defined as a rear side of the printer 1. Moreover, left and right sides of the printer 1 will be defined with a left-to-right direction as a horizontally-extending direction when the printer 1 is viewed from the front side. Namely, in a direction perpendicular to the sheet of FIG. 1, the near side of FIG. 1 will be defined as a left side of the printer 1, and the far side of FIG. 1 will be defined as a right side of the printer 1.

(1) Main Body Casing

The main body casing 2 has a cartridge opening 5 and a sheet supply opening 6. The cartridge opening is an opening through which a below-mentioned process cartridge 15 is attached to or detached from the main body casing 2. The sheet supply opening 6 is an opening through which sheets P are set.

The cartridge opening 5 is formed to vertically penetrate an upper end portion of the main body casing 2.

The sheet supply opening 6 is formed to penetrate a front end portion of the main body casing 2 in the front-to-rear direction.

Further, the main body casing 2 includes a top cover 7 disposed at an upper end portion of the main body casing 2, and a sheet feeding cover 8 disposed at a front end portion of the main body casing 2.

The top cover 7 is configured to swing around a rear end portion thereof as a pivot point, between a closed position and an open position. When the top cover 7 is in the closed position indicated by a solid line in FIG. 1, the cartridge opening 5 is closed. When the top cover 7 is in the open position indicated by a virtual line (a long dashed double-short dashed line) in FIG. 1, the cartridge opening 5 is open.

The sheet feeding cover 8 is configured to swing around a lower end portion thereof as a pivot point, between a closed position and an open position. When the sheet feeding cover 8 is in the closed position indicated by a solid line in FIG. 1, the sheet supply opening 6 is closed. When the sheet feeding cover 8 is in the open position indicated by a virtual line (a long dashed double-short dashed line) in FIG. 1, the sheet supply opening 6 is open.

(2) Sheet Feeder

The sheet feeder 3 includes a sheet placement portion 9 disposed at a bottom portion of the main body casing 2.

The sheet placement portion 9 is configured to communicate with an outside of the main body casing 2 via the sheet supply opening 6.

When the sheet feeding cover 8 is in the open position, a front portion of a sheet P is placed on an upper surface of the sheet feeding cover 8, and a rear portion of the sheet P is placed on the sheet placement portion 9 via the sheet supply opening 6.

Further, the sheet feeder 3 includes a pickup roller 11, a feed roller 12, a feed pad 13, and a feeding path 14. The pickup roller 11 is disposed at an upper rear side of the sheet placement portion 9. The feed roller 12 is disposed behind the pickup roller 11. The feed pad 13 is disposed to face the feed roller 12, at a lower rear side of the feed roller 12. The feed path 14 continuously extends upward from a rear end portion of the feed pad 13.

(3) Image Forming Unit

The image forming unit 4 includes a process cartridge 15, a scanning unit 16, and a fuser unit 17.

(3-1) Process Cartridge

The process cartridge 15 is configured to be detachably attached to the main body casing 2, at an upper side of a rear portion of the sheet feeder 3.

The process cartridge 15 includes a drum cartridge 18 configured to be detachably attached to the main body casing 2, and a development cartridge 19 configured to be detachably attached to the drum cartridge 18.

The drum cartridge 18 includes a photoconductive drum 20, a transfer roller 21, and a scorotron charger 22.

The photoconductive drum 20 is formed substantially in a cylindrical shape extending in the left-to-right direction. The photoconductive drum 20 is rotatably supported at a rear portion of the drum cartridge 18.

The transfer roller 21 is formed substantially in a cylindrical shape extending in the left-to-right direction. The transfer roller 21 is rotatably supported at a rear portion of the drum cartridge. The transfer roller 21 is in pressure contact with a rear end portion of the photoconductive drum 20.

The scorotron charger 22 is supported by the drum cartridge 18 so as to be disposed apart from the photoconductive drum 20 at an upper front side of the photoconductive drum 20.

The development cartridge 19 is disposed at a lower front side of the photoconductive drum 20. The development cartridge 19 includes a development frame 25.

In the development frame 25, a toner compartment 26 and a development compartment 27 are arranged side by side in the front-to-rear direction. The toner compartment 26 and the development compartment 27 are configured to communicate with each other via a communication opening 28.

The toner compartment 26 is configured to contain (store) toner. The toner compartment 26 includes an agitator 29 disposed substantially at a central portion of the toner compartment 26 in the front-to-rear direction and the vertical direction.

Further, the development frame 25 includes, in the development compartment 27, a supply roller 33, a development roller 34, and a layer-thickness restricting blade 35.

The supply roller 33 is rotatably disposed at a rear portion of the development compartment 27.

The development roller 34 is rotatably disposed at a rear portion of the development compartment 27.

The development roller 34 is disposed to contact an upper rear end portion of the supply roller and a lower front end portion of the photoconductive drum 20. Further, the development roller 34 is disposed such that an upper portion and a rear portion thereof are exposed out of the development compartment 27.

The layer-thickness restricting blade 35 is configured such that an upper end portion thereof is fixedly attached to a rear end portion of an upper wall of the development compartment 27. Further, the layer-thickness restricting blade 35 is disposed such that a lower end portion thereof contacts a front end portion of the development roller 34.

(3-2) Scanning Unit

The scanning unit 16 is spaced apart from the photoconductive drum 20 in the front-to-rear direction, in front of the process cartridge 15.

The scanning unit 16 is configured to emit a laser beam L toward the photoconductive drum 20 and expose a circumferential surface of the photoconductive drum 20, based on image data.

Specifically, the laser beam L is emitted rearward by the scanning unit 16 so as to expose a circumferential surface of a front end portion of the photoconductive drum 20.

(3-3) Fuser Unit

The fuser unit 17 is disposed above a rear portion of the drum cartridge 18. The fuser unit 17 includes a heating roller 38 disposed above the scorotron charger 22, and a pressing roller 39 in pressure contact with an upper rear portion of the heating roller 38.

(4) Image Forming Operation

The toner stored in the toner compartment 26 of the development cartridge 19 is supplied to the supply roller 33 via the communication opening 28 by rotation of the agitator 29. Further, the toner is supplied to the development roller 34, and positively charged by friction between the supply roller 33 and the development roller 34.

The toner supplied to the development roller 34 is carried on a surface of the development roller 34 as a thin layer having a constant thickness restricted by the layer-thickness restricting blade 35 in response to rotation of the development roller 34.

In the meantime, the circumferential surface of the photoconductive drum 20 is evenly charged by the scorotron charger 22, and thereafter exposed by the scanning unit 16. Thereby, on the circumferential surface of the photoconductive drum 20, an electrostatic latent image is formed based on the image data. Then, when the toner carried on the development roller 34 is supplied to the electrostatic latent image formed on the circumferential surface of the photoconductive drum 20, a toner image is carried on the circumferential surface of the photoconductive drum 20.

Sheets P stacked on the sheet placement portion 9 are fed between the feed roller 12 and the feed pad 13 by rotation of the pickup roller 11. Then, by rotation of the feed roller 12, the sheets P are separated on a sheet-by-sheet basis. Thereafter, in response to the rotation of the feed roller 12, the sheets P are conveyed on the feeding path 14, and fed between the photoconductive drum 20 and the transfer roller 21 in the image forming unit 4 on a sheet-by-sheet basis with predetermined timing.

Then, the sheets P are conveyed between the photoconductive drum 20 and the transfer roller 21, such that toner images are transferred thereon. Thus, images are formed on the sheets P.

When passing between the heating roller 38 and the pressing roller 39, the sheets P are heated and pressed therebetween. At this time, the images are thermally fixed onto the sheets P.

Afterward, the sheets P are conveyed toward ejection rollers 40, and ejected by the ejection rollers 40 onto a catch tray 41 formed on an upper surface of the main body casing 2.

Thus, the sheets P are conveyed on a conveyance path that is substantially C-shaped in a side view, so as to, after fed from the sheet placement portion 9, pass between the photoconductive drum 20 and the transfer roller 21, then pass between the heating roller 38 and the pressing roller 39, and thereafter be ejected onto the catch tray 41.

2. Details about Main Body Casing

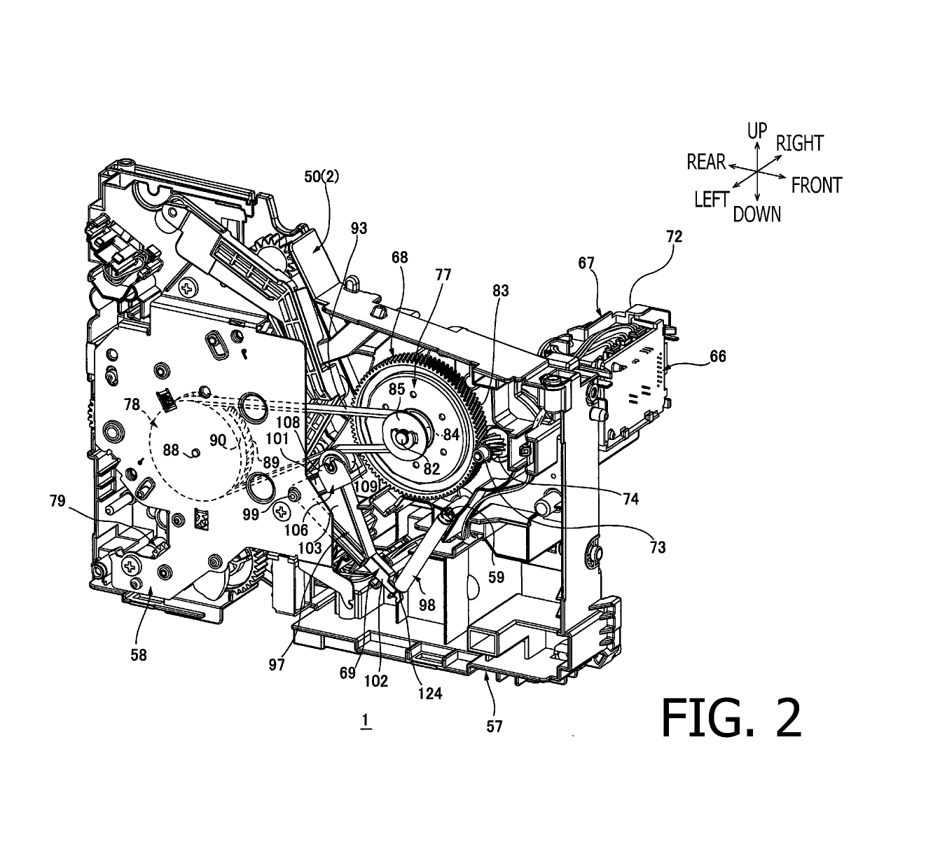

The main body casing 2 includes a left wall 50 as shown in FIG. 2. Further, the main body casing 2 includes a right wall 51, a front wall 52, a rear wall 53, an upper wall 54, and a lower wall 55 as shown in FIG. 1.

As shown in FIG. 2, the left wall 50 is disposed at a left end portion of the main body casing 2. The left wall 50 includes a resin frame 57, a metal frame 58, and a cover frame (not shown).

The resin frame 57 is made of ABS resin. The resin frame 57 extends in the vertical direction and the front-to-rear direction, and is formed substantially in a bottomed rectangular frame shape having an open left side in a side view. The resin frame 57 includes a first hook 59, a drive shaft 82, an input shaft 88, and a swing shaft 99. Further, the resin frame 57 is configured to support a below-mentioned drive disk 77 and a below-mentioned input disk 78.

The first hook 59 extends leftward from a substantially middle portion of a front part of the resin frame 57 in the vertical direction and the front-to-rear direction, and is bent upward from a left end portion of the first hook 59. Thus, the first hook 59 has a substantially L-shaped claw form in a front view.

The drive shaft 82 is formed substantially in a cylindrical shape extending leftward from an upper front portion of the resin frame 57.

The input shaft 88 is formed substantially in a cylindrical shape extending leftward from a substantially middle portion of a rear part of the resin frame 57 in the vertical direction. As shown in FIG. 2, a left end portion of the input shaft 88 is supported by the below-mentioned metal frame 58.

The swing shaft 99 is formed substantially in a cylindrical shape extending leftward from a substantially middle portion of the resin frame 57 in the vertical direction and the front-to-rear direction. A left end portion of the swing shaft 99 is supported by the below-mentioned metal frame 58.

Further, the resin frame 57 includes rotational shafts of various gears of a below-mentioned gear train 79. Each rotational shaft of various gears of the below-mentioned gear train 79 is formed substantially in a cylindrical shape extending leftward at a rear portion of the resin frame 57. A left end portion of each rotational shaft of various gears of the below-mentioned gear train 79 is supported by the below-mentioned metal frame 58.

The metal frame 58 is made of electrolytic zinc-coated steel sheets (SECC: Steel Electrolytic Cold Commercial). The metal frame 58 is spaced apart leftward from a right surface of the resin frame 57. In other words, the metal frame 58 is spaced apart from the resin frame 57, on one side of the resin frame 57 in a third direction perpendicular to a below-mentioned first direction and a below-mentioned second direction. The metal frame 58 is formed substantially in a rectangular flat plate shape extending in the vertical direction and the front-to-rear direction, in a side view. The metal frame 58 is disposed to cover a rear portion of the resin frame 57 from the left.

The left wall 50 is formed with the cover frame (not shown) covering the resin frame 57 and the metal frame 58 from the left.

As shown in FIG. 1, the right wall 51 is disposed at a right end portion of the main body casing 2, so as to be spaced apart rightward from the left wall 50. The right wall 51 is formed substantially in a rectangular shape extending in the vertical direction and the front-to-rear direction, in a side view.

The front wall 52 is configured to bridge a distance between respective front end portions of the left wall 50 and the right wall 51. The front wall 52 is formed substantially in a flat plate shape extending in the vertical direction and the left-to-right direction. The front wall 52 includes the aforementioned sheet supply opening 6 and the aforementioned sheet feeding cover 8 configured to swing to be able to open and close the sheet supply opening 6.

The rear wall 53 is configured to bridge a distance between respective rear end portions of the left wall 50 and the right wall 51. The rear wall 53 is formed substantially in a flat plate shape extending in the vertical direction and the left-to-right direction.

The upper wall 54 is configured to bridge a distance between respective upper end portions of the left wall 50 and the right wall 51. The upper wall 54 is formed substantially in a flat plate shape extending the front-to-rear direction and the left-to-right direction. The upper wall 54 includes the aforementioned cartridge opening 5 and the aforementioned top cover 7 configured to swing to be able to open and close the cartridge opening 5.

The lower wall 55 is configured to bridge a distance between respective lower end portions of the left wall 50 and the right wall 51. The lower wall 55 is formed substantially in a flat plate shape extending in the front-to-rear direction and the left-to-right direction. The lower wall 55 includes the aforementioned sheet placement portion 9.

3. Details of Driving Force Transmitting Unit

The printer 1 includes a driving force transmitting unit 66 inside the main body casing 2, in order to rotate the aforementioned rotational bodies configured to rotate in an image forming operation, such as the pickup roller 11, the feed roller 12, the photoconductive drum 20, the transfer roller 21, the agitator 29, the supply roller 33, the development roller 34 (the above elements 20, 21, 29, 33, and 34 in the process cartridge 15), the heating roller 38, and the pressing roller 39.

As shown in FIG. 2, the driving force transmitting unit 66 includes a motor 67, a driving force transmitting mechanism 68, and a pressing mechanism 69.

(1) Motor

The motor 67 is disposed at a left end portion of an upper part of the main body casing 2. The motor 67 is configured to generate a rotational driving force when supplied with electricity from an external power supply (not shown). The motor 67 includes a motor main body 72 and a motor shaft 73.

The motor main body 72 is formed substantially in a rectangular box shape in a front view. The motor main body 72 is disposed in the main body casing 2 in such a manner that a front face of the motor main body 72 is supported by the front wall 52, and a left face of the motor main body 72 is supported by the resin frame 57.

The motor shaft 73 is formed substantially in a cylindrical shape extending leftward beyond a left end of the motor main body 72 from an inside of the motor main body 72. The motor shaft 73 is configured such that a left end thereof penetrates the resin frame 57 in the left-to-right direction. The motor shaft 73 is configured to rotate when supplied with electricity from the external power supply (not shown). The motor shaft 73 includes a pinion gear 74.

The pinion gear 74 is connected with a left end portion of the motor shaft 73. The pinion gear 74 is a helical gear configured to rotate so as to be restricted from rotating relative to the motor shaft 73.

(2) Driving Force Transmitting Mechanism

The driving force transmitting mechanism 68 includes a drive disk 77, an input disk 78, a belt 93, and a gear train 79.

The drive disk 77 is configured to transmit the driving force from the motor 67. The drive disk 77 is rotatably supported by the drive shaft 82, on a left side of the resin frame 57 (i.e., on a left side relative to the resin frame 57). The drive disk 77 includes a drive gear 83, a drive pulley 84, and a flange 85.

The drive gear 83 is formed substantially in a circular flat plate shape that is coaxial with the drive shaft 82, in a side view. The drive gear 83 is rotatably supported by the drive shaft 82. A diameter of the drive gear 83 is larger than a diameter of the drive shaft 82. Further, a length of the drive gear 83 in the left-to-right direction is smaller than a length of the drive shaft 82 in the left-to-right direction. The drive gear 83 is a helical gear configured to engage with the pinion gear 74.

The drive pulley 84 is left-adjacent to the drive gear 83. The drive pulley 84 is formed substantially in a circular flat plate shape that is coaxial with the drive shaft 82, in a side view. The drive pulley 84 is supported by the drive shaft 82 so as to be rotatable integrally with the drive gear 83. A diameter of the drive pulley 84 is larger than the diameter of the drive shaft 82, and smaller than the diameter of the drive gear 83. Further, a length of the drive pulley 84 in the left-to-right direction is smaller than the length of the drive shaft 82 in the left-to-right direction.

The flange 85 is disposed left-adjacent to the drive pulley 84, at a left end portion of the drive shaft 82. The flange 85 is formed substantially in a circular flat plate shape that is coaxial with the drive shaft 82, in a side view. The flange 85 is supported by the drive shaft 82 so as to be rotatable integrally with the drive pulley 84. A diameter of the flange 85 is larger than the diameter of the drive pulley 84, and smaller than the diameter of the drive gear 83.

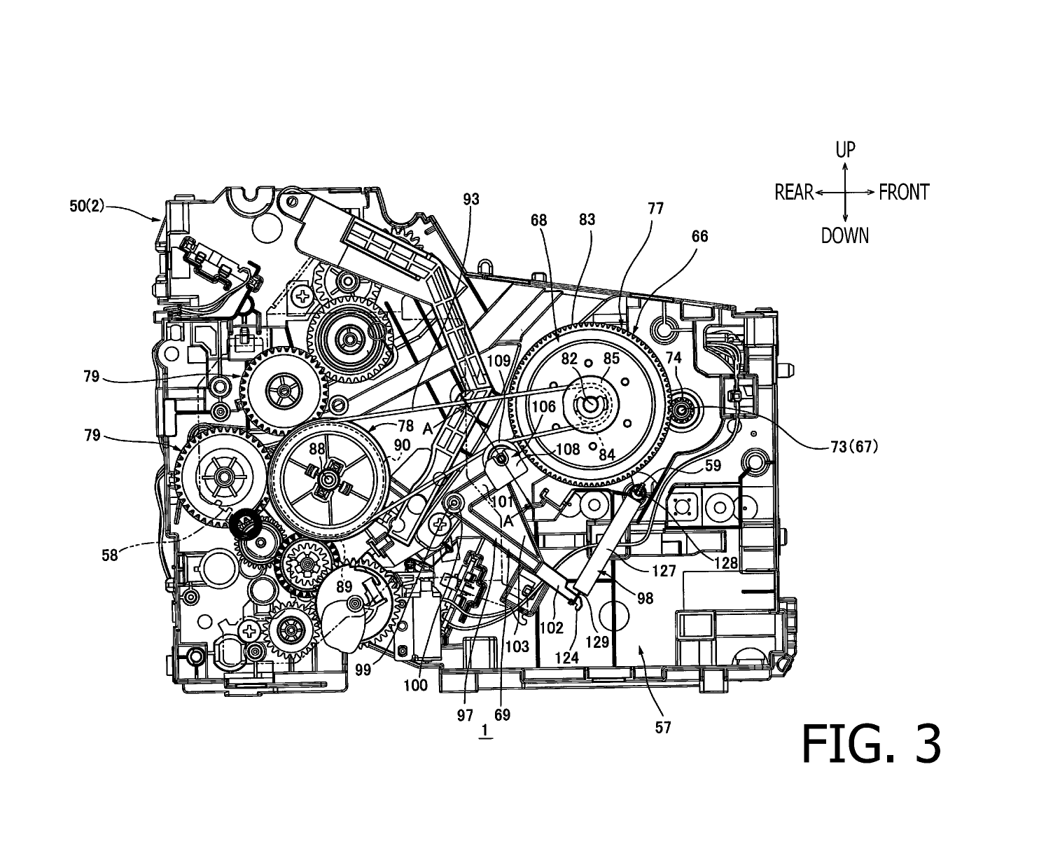

The input disk 78 is configured to input the driving force to the image forming unit 4 via the below-mentioned gear train 79. As shown in FIG. 3, the input disk 78 is rotatably supported by the input shaft 88, on a left side of the resin frame 57 and on a right side of the metal frame 58. That is, the input disk 78 is disposed to be sandwiched between the resin frame 57 and the metal frame 58. The input disk 78 is supported by the resin frame 57 so as to be spaced apart from the drive disk 77, on a lower rear side of the drive disk 77. The input disk 78 includes an input gear 89 and an input pulley 90.

As shown in FIG. 3, the input gear 89 is formed substantially in a circular flat plate shape that is coaxial with the input shaft 88, in a side view. The input gear 89 is rotatably supported by the input shaft 88. A diameter of the input gear 89 is larger than the diameter of the input shaft 88. Further, a length of the input gear 89 in the left-to-right direction is smaller than the length of the input shaft 88 in the left-to-right direction. The input gear 89 is a gear having spur teeth.

The input pulley 90 is left-adjacent to the input gear 89. The input pulley 90 is formed substantially in a circular flat plate shape that is coaxial with the input shaft 88. The input pulley 90 is supported by the input shaft 88 so as to be rotatable integrally with the input gear 89. A diameter of the input pulley 90 is substantially as large as the diameter of the input gear 89, and larger than the diameter of the drive pulley 84. Further, a length of the input pulley 90 in the left-to-right direction is smaller than the length of the input shaft 88 in the left-to-right direction.

The belt 93 is an endless belt configured to transmit, to the input disk 78, the driving force transmitted from the motor 67 to the drive disk 77. The belt 93 is wound around the two pulleys, i.e., the drive pulley 84 of the drive disk 77 and the input pulley 90 of the input disk 78. The belt 93 is configured to turn clockwise or counterclockwise in a side view by the driving force from the motor 67.

The gear train 79 includes a plurality of gears configured to transmit the driving force to a plurality of rotational bodies that rotate in an image forming operation. Specifically, for instance, the gear train 79 includes a gear configured to transmit the driving force to the pickup roller 11, a gear configured to transmit the driving force to the feed roller 12, a gear configured to transmit the driving force to the heating roller 38, a gear configured to transmit the driving force to the pressing roller 39, a gear configured to transmit the driving force to (at least one of) the ejection rollers 40, and coupling gears configured to transmit the driving force to the photoconductive drum 20, the transfer roller 21, the agitator 29, the supply roller 33, and the development roller 34 in the process cartridge 15. The gear train 79 is rotatably supported by a rear portion of the resin frame 57 in a side view, on a left side of the resin frame 57 and on a right side of the metal frame 58. The gear train 79 is configured to receive the driving force transmitted from the motor 67 via the input disk 78. Thus, by the driving force generated by the motor 67, rotated are the pickup roller 11, the feed roller 12, the photoconductive drum 20, the transfer roller 21, the agitator 29, the supply roller 33, the development roller 34 (the above elements 20, 21, 29, 33, and 34 in the process cartridge 15), the heating roller 38, the pressing roller 39, and (at least one of) the ejection rollers 40.

(3) Pressing Mechanism

The pressing mechanism 69 is configured to apply a tension to the belt 93 so as to assist transmission of the driving force from the drive disk 77 to the input disk 78. The pressing mechanism 69 includes a swingable member 97 and a tension spring 98.

The swingable member 97 is swingably supported at a substantially middle portion of the resin frame 57 in the vertical direction and the front-to-rear direction in a side view, on a left side of the resin frame 57 and a right side of the metal frame 58. The swingable member 97 includes a pivot portion 100, a first portion 101, a pressing portion 106, a second portion 102, a second hook 124, and a reinforcing plate 103.

The pivot portion 100 is formed substantially in a cylindrical shape that is coaxial with the swing shaft 99. The pivot portion 100 is rotatably supported by the swing shaft 99. That is, the pivot portion 100 is supported so as to be sandwiched between the resin frame 57 and the metal frame 58.

The first portion 101 is formed in a bar shape extending toward an upper front side from a circumferential surface of the pivot portion 100. Hereinafter, the extending direction of the first portion 101 may be referred to as a first direction. Namely, the first direction is a direction extending from a lower rear side toward an upper front side.

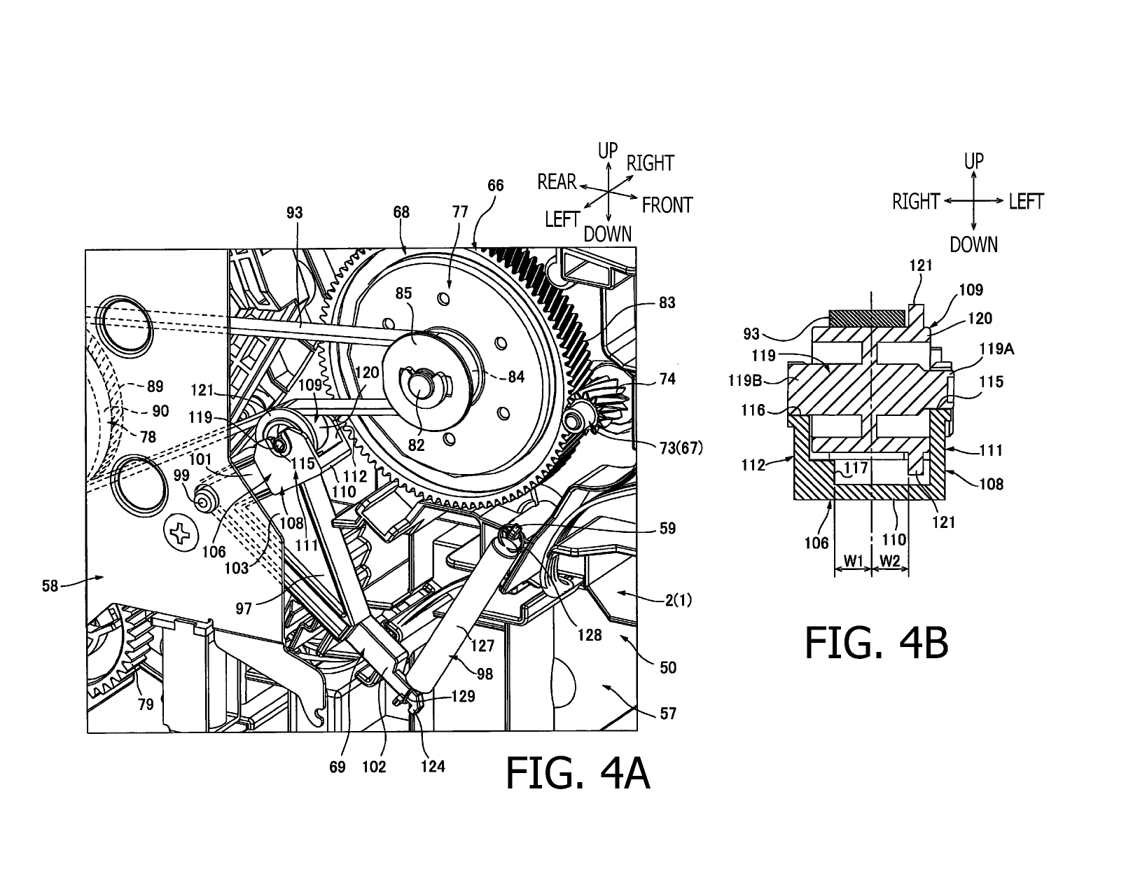

The pressing portion 106 is disposed at a free end portion (i.e., an upper front end portion) of the first portion 101. Namely, the pressing portion 106 is spaced apart in the first direction from the pivot portion 100. As shown in FIG. 4A, the pressing portion 106 includes a holder 108 and a contact roller 109.

The holder 108 includes a bottom plate 110, a left plate 111, a right plate 112, and an interference portion 117.

The bottom plate 110, extending toward an upper front side continuously from the upper front end portion of the first portion 101, is disposed at a lower end portion of the holder 108. The bottom plate 110 is formed substantially in a flat plate shape extending in the front-to-rear direction and the left-to-right direction.

The left plate 111, extending upward continuously from a left end of the bottom plate 110, is disposed at a left end portion of the holder 108. The left plate 111 is formed substantially in a rectangular flat plate extending in the vertical direction and the front-to-rear direction, in a side view. The left plate 111 includes a left bearing groove 115.

The left bearing groove 115 is a groove cut down from a substantially middle portion of an upper surface of the left plate 111 in the front-to-rear direction. The left bearing groove 115 is formed substantially in a U-shape in a side view. The left bearing groove 115 is configured to support a left end portion of a below-mentioned roller shaft 119.

The right plate 112, extending upward continuously from a right end of the bottom plate 110, is spaced apart rightward from the left plate 111, and disposed at a right end portion of the holder 108. The right plate 112 is formed substantially in a rectangular flat plate shape extending in the vertical direction and the front-to-rear direction, in a side view. The right plate 112 includes a right bearing groove 116.

The right bearing groove 116 is a groove cut down from a substantially middle portion of an upper surface of the right plate 112 in the front-to-rear direction. The right bearing groove 116 is formed substantially in a U-shape in a side view. When projected in the left-to-right direction, an inner shape of the right bearing groove 116 is larger than an inner shape of the left bearing groove 115. The right bearing groove 116 is configured to support a right end portion of the below-mentioned roller shaft 119.

The interference portion 117 is formed substantially in a rectangular flat plate shape bulging toward an upper left side in a front view, at a continuous joint portion between the right plate 112 and the bottom plate 110 at a substantially middle portion of the holder 108 in the front-to-rear direction. In a state where the below-mentioned contact roller 109 is attached to the holder 108, a distance from a center of the contact roller 109 in the left-to-right direction to the interference portion 17 will hereinafter be defined as a distance W1.

The contact roller 109 includes a roller shaft 119, a roller main body 120, and a restricting portion 121.

The roller shaft 119 is formed substantially in a cylindrical shape extending in the left-to-right direction. Further, the roller shaft 119 is formed to be uneven such that a diameter of a left end portion of the roller shaft 119 is smaller than a diameter of a right end portion of the roller shaft 119. Hereinafter, of the roller shaft 119, the left end portion having a relatively smaller diameter will be referred to as a left end section 119A, and the right end portion having a relatively larger diameter will be referred to as a right end section 119B.

The roller main body 120 is formed substantially in a cylindrical shape. The roller main body 120 is configured to cover and surround the roller shaft 119 such that both end portions of the roller shaft 119 in the left-to-right direction (i.e., the left end section 119A and the right end section 119B) are exposed.

The restricting portion 121 is formed substantially in a circular flat plate shape in a side view. More specifically, the restricting portion 121 protrudes outward in a radial direction of the roller main body 120 from a circumferential surface of a left end portion of the roller main body 120 (i.e., an end portion of the roller main body 120 opposite to the resin frame 57). The restricting portion 121 is configured to restrict the belt 93 from moving leftward or coming off when the contact roller 109 is pressing the belt 93. It is noted that a distance from the center of the contact roller 109 in the left-to-right direction to the restricting portion 121 will hereinafter be defined as a distance W2. The distance W2 from the center of the contact roller 109 in the left-to-right direction to the restricting portion 121 is substantially identical to the distance W1 from the center of the contact roller 109 in the left-to-right direction to the interference portion 17. In other words, the restricting portion 121 is disposed in a position line-symmetrical to the interference portion 117 with respect to the center of the contact roller 109 in the left-to-right direction.

Further, the contact roller 109 is rotatably supported by the holder 108, with the left end portion of the roller shaft 119 (i.e., the left end section 119A) being supported by the left bearing groove 115, and the right end portion of the roller shaft 119 (i.e., the right end section 119B) being supported by the right bearing groove 116.

The second portion 102 is formed in a bar shape extending toward a lower front side from a circumferential surface of the pivot portion 100. The extending direction of the second portion may hereinafter be referred to as a second direction. The second direction is a direction extending from an upper rear side toward a lower front side, and is different from the first direction.

The second hook 124 is disposed at a free end portion (i.e., a lower front end portion) of the second portion 102. Namely, the second hook 124 is spaced apart in the second direction from the pivot portion 100. The second hook 124 is formed substantially in a claw shape, which extends toward a lower front side continuously from a lower front end portion of the second portion 102, and is bent toward a lower rear side from a lower front end portion of the second hook 124. It is noted that a distance between the pivot portion 100 and the second hook 124 is longer than a distance between the pivot portion 100 and the pressing portion 106.

The reinforcing plate 103 is configured to bridge a distance between the first portion 101 and the second portion 102. The reinforcing plate 103 is formed substantially in a triangle flat plate shape in a side view.

The tension spring 98 includes a spring main body 127, a first engagement portion 128, and a second engagement portion 129.

The spring main body 127 includes a spiral wire member extending along a direction from an upper front side toward a lower rear side (i.e., substantially along the first direction).

The first engagement portion 128 is formed substantially in a ring shape continuous with an upper end portion of the spiral wire member of the spring main body 127, in a side view. The first engagement portion 128 is engaged with the first hook 59 of the resin frame 57.

The second engagement portion 129 is formed substantially in a ring shape continuous with a lower end portion of the spiral wire member of the spring main body 127, in a front view. The second engagement portion 129 is engaged with the second hook 124. Thereby, the second hook 124 is urged toward an upper front side by the tension spring 98.

Thus, in the pressing mechanism 69, the swingable member 97 is urged by an urging force of the tension spring 98 so as to swing counterclockwise around the swing shaft 99, in a left side view (i.e., when viewed from the left side).

Further, the contact roller 109 of the pressing portion 106 urges a lower portion of the belt 93 upward from beneath.

4. Transmission of Driving Force

In the driving force transmitting unit 66, by the driving force from the motor 67, various rotational bodies are rotated, such as the pickup roller 11, the feed roller 12, the photoconductive drum 20, the transfer roller 21, the agitator 29, the supply roller 33, the development roller 34 (the above elements 20, 21, 29, 33, and 34 in the process cartridge 15), the heating roller 38, the pressing roller 39, and (at least one of) the ejection rollers 40.

Specifically, when the motor 67 is supplied with electricity from an external power supply, the motor shaft 73 of the motor 67 is driven to rotate.

Then, the driving force is transmitted from the pinion gear 74 of the motor shaft 73 to the drive disk 77 via the drive gear 83.

The driving force transmitted to the drive disk 77 is transmitted to the input disk 78 via the belt 93 wound around the drive pulley 84 and the input pulley 90.

A tension is applied to the belt 93, as the contact roller 109 of the pressing portion 106 of the pressing mechanism 69 contacts and presses the belt 93 from beneath.

Therefore, the driving force is transmitted from the drive pulley 84 to the input pulley 90 in a substantially lossless manner with a high level of efficiency.

Then, as shown in FIG. 3, the driving force transmitted to the input disk 78 is transmitted to a plurality of gears of the gear train 79 via the input gear 89.

Thereby, the driving force is transmitted to various rotational bodies so as to rotate the rotational bodies, such as the pickup roller 11, the feed roller 12, the photoconductive drum 20, the transfer roller 21, the agitator 29, the supply roller 33, the development roller 34 (the above elements 20, 21, 29, 33, and 34 in the process cartridge 15), the heating roller 38, and the pressing roller 39.

5. Operations and Advantageous Effects

(1) According to the printer 1, as shown in FIG. 3, the swingable member 97 includes the pivot portion 100, the pressing portion 106 spaced apart in the first direction from the pivot portion 100, and the second hook 124 spaced apart in the second direction from the pivot portion 100. Further, the tension spring 98 is engaged with the first hook 59 of the main body casing 2 and the second hook 124 of the swingable member 97, so as to urge the swingable member 97. Thereby, the pressing portion 106 presses the belt 93 so as to apply a tension to the belt 93.

In other words, in the swingable member 97, the pressing portion 106 in contact with the belt 93 and the second hook 124 urged by the tension spring 98 are spaced apart in the first direction and the second direction from the pivot portion 100, respectively. Therefore, there is no need to dispose the tension spring 98 in such a position as to generate an urging force in a direction substantially perpendicular to the traveling direction of the belt 93.

Consequently, with a simple configuration, it is possible to improve flexibility in the layout of the pressing mechanism 69, and to certainly apply a tension to the belt 93.

(2) When a pressing mechanism is employed that includes an urging member configured to apply an urging force in a direction substantially perpendicular to the traveling direction of the belt 93, it is required to set high the urging force to be applied to the belt 93.

However, according to the printer 1, as shown in FIG. 3, the pressing portion 106 is brought into contact with the belt 93 by urging the second hook 124, which is disposed a longer distance away from the pivot portion 100 than the pressing portion 106, so as to swing the swingable member 97.

Therefore, even though the urging force to urge the second hook 124 is low, it is possible to certainly make the pressing portion 106 press the belt 93 in accordance with the principle of leverage.

Consequently, it is possible to employ a tension spring for generating a low urging force as the tension spring 98 for applying a tension to the belt 93.

(3) According to the printer 1, as shown in FIG. 2, it is possible to secure a desired level of strength of the printer 1 as the resin frame 57 and the metal frame 58 are provided at the left wall 50 of the main body casing 2 where the drive disk 77, the input disk 78, and the gear train 79 are disposed.
(4) According to the printer 1, as shown in FIGS. 3, 4A, and 4B, the pivot portion 100 is supported by the swing shaft 99 that protrudes from the resin frame 57 and is supported by the metal frame 58. Thereby, the swingable member 98 is supported so as to be sandwiched between the resin frame 57 and the metal frame 58. Hence, it is possible to prevent the swingable member 97 from falling in the left-to-right direction when the urging force is applied by the tension spring 98.

Therefore, it is possible to prevent the pressing portion 106 from positionally shifting in the left-to-right direction relative to the belt 93.

Consequently, it is possible to certainly apply a tension to the belt 93.

(5) According to the printer 1, as shown in FIGS. 4A and 4B, the belt 93 is pressed when the swingable member 97 is urged by the tension spring 98, and the contact roller 109 of the pressing portion 106 is brought into contact with the belt 93. Further, the belt 93 is restricted from moving leftward by the restricting portion 121.

Therefore, it is possible to prevent release of a pressing state where the pressing mechanism 69 presses the belt 93.

Consequently, it is possible to more certainly apply a tension to the belt 93.

(6) According to the printer 1, as shown in FIGS. 4A and 4B, the belt 93 is restricted from moving leftward by contact with the restricting portion 121 that protrudes in the radial direction of the contact roller 109 from the left end portion of the contact roller 109.

Therefore, by such a simple configuration as to include the restricting portion 121 protruding radially from the left end portion of the contact roller 109, it is possible to certainly prevent release of the pressing state where the pressing mechanism 69 presses the belt 93.

(7) According to the printer 1, as shown in FIGS. 4A and 4B, in an assembling operation of attaching the contact roller 109 to the holder 108, there is no way other than to attach the contact roller 109 to the holder 108 without any interference (e.g., contact) between the restricting portion 121 and the interference portion 117. Thus, it is possible to avoid a wrong assembling manner to attach the contact roller 109 to the holder 108.

Further, in the roller shaft 119, the diameters of the left end section 119A and the right end section 119B are different from each other. Thereby, there is no way other than to set the left end section 119A and the right end section 119B into the left bearing groove 115 and the right bearing groove 116, respectively. Thus, it is possible to avoid a wrong assembling manner to attach the contact roller 109 to the holder 108.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein.

What is claimed is:

1. An image forming apparatus comprising:
a driving source configured to generate a driving force;
a drive section configured to receive the driving force from the driving source;
an input section spaced apart from the drive section, the input section configured to input, to an image forming unit, the driving force transmitted from the driving source via the drive section;
a belt wound around the drive section and the input section, the belt configured to transmit the driving force from the drive section to the input section; and
a pressing mechanism configured to apply a tension to the belt, the pressing mechanism comprising:
an urging member; and
a swing member configured to swing to press the belt when urged by the urging member, the swing member comprising:
a pivot portion configured to serve as a pivot point around which the swing member swings;
a first end portion spaced apart in a first direction from the pivot portion, the first end portion configured to contact the belt; and
a second end portion spaced apart, in a second direction different from the first direction, from the pivot portion, the second end portion configured to be urged by the urging member.

2. The image forming apparatus according to claim 1,
wherein a distance between the pivot portion and the second end portion is longer than a distance between the pivot portion and the first end portion.

3. The image forming apparatus according to claim 1, further comprising:
a first frame configured to support the input section and the drive section; and
a second frame spaced apart from the first frame, and disposed on one side of the first frame in a third direction perpendicular to the first direction and the second direction.

4. The image forming apparatus according to claim 3,
wherein the pivot portion is supported so as to be sandwiched between the first frame and the second frame.

5. The image forming apparatus according to claim 3,
wherein the first end portion comprises:
a contact member configured to contact the belt, the contact member comprising a restricting portion configured to restrict the belt from moving in the third direction; and
a supporting member configured to support the contact member.

6. The image forming apparatus according to claim 5,
wherein the contact member comprises a roller having a rotational axis along the third direction, and
wherein the restricting portion is formed to protrude in a radial direction of the roller from one end portion of the roller in the third direction.

7. The image forming apparatus according to claim 6,
wherein the restricting portion is disposed only at the one end portion of the contact member in the third direction, and
wherein the supporting member comprises an interference portion disposed in a position line-symmetrical to the restricting portion with respect to a center of the contact member in the third direction, the interference portion formed to protrude toward the contact member from the supporting member.
